(19) United States
(12) Patent Application Publication
(10) Pub. No.: US 2026/0252244 A1
(43) Pub. Date: Aug. 27, 2026

(54) POWER EFFICIENT ACCESS TO STORAGE

(71) Applicant: Arm Limited, Cambridge, Cambridgeshire (GB)

(72) Inventors: Alexander Cole SHULYAK, Austin, TX (US); Houdhaifa BOUZGUARROU, Valbonne (FR); Rami Mohammad AL SHEIKH, Morrisville, NC (US); Zachary Allen KINGSBURY, Austin, TX (US); Joshua David KNEBEL, Austin, TX (US)

(21) Appl. No.: 19/065,080

(22) Filed: Feb. 27, 2025

(51) Int. Cl. G06F 3/06

(52) U.S. Cl. CPC G06F 3/0625; G06F 3/0655; G06F 3/0673

(57) ABSTRACT

A data processing apparatus is provided that includes a plurality of storage circuits, each storing data items in association with tags. Indication circuitry indicates, for a partial tag that is provided as an input, a subset of the storage circuits where the partial tag is part of the tags stored in that storage circuit, and causes the subset of the storage circuits to be powered to a power level at which the subset of the storage circuits can be accessed. Access circuitry searches the subset of the storage circuits for a tag comprising the partial tag once the indication circuitry has caused the subset of storage circuits to be powered.

### TECHNICAL FIELD

The present disclosure relates to data processing and particularly efficient access to storage circuits.

### DESCRIPTION

It is desirable to access storage circuitry, such as RAMs efficiently. There are a number of storage mechanisms in which relevant data may be stored in one of a number of different locations and in these circumstances searching each location can consume a large amount of power. This is particularly, but not exclusively, true of predictors, which may use a large amount of data. It is also desirable for such storage circuitry to be searched quickly so as to not impact processing speed.

### SUMMARY

Viewed from a first example configuration, there is provided a data processing apparatus comprising: a plurality of storage circuits, each configured to store data items in association with tags; indication circuitry configured to indicate, for a partial tag that is provided as an input, a subset of the storage circuits where the partial tag is part of the tags stored in that storage circuit, and to cause the subset of the storage circuits to be powered to a power level at which the subset of the storage circuits can be accessed; and access circuitry configured to search the subset of the storage circuits for a tag comprising the partial tag once the indication circuitry has caused the subset of storage circuits to be powered.

Viewed from a second example configuration, there is provided a system comprising: the data processing apparatus, implemented in at least one packaged chip; at least one system component; and a board, wherein the at least one packaged chip and the at least one system component are assembled on the board.

Viewed from a third example configuration, there is provided a chip-containing product comprising the system, wherein the system is assembled on a further board with at least one other product component.

Viewed from a fourth example configuration, there is provided a data processing method comprising: storing data items in association with tags in a plurality of storage circuits; indicating, for a partial tag that is provided as an input, a subset of the storage circuits where the partial tag is part of the tags stored in that storage circuit; causing the subset of the storage circuits to be powered to a power level at which the subset of the storage circuits can be accessed; and searching the subset of the storage circuits for a tag comprising the partial tag once the subset of storage circuits have been powered.

Viewed from a fifth example configuration, there is provided a non-transitory computer-readable medium storing computer-readable code for fabrication of the data processing apparatus.

### BRIEF DESCRIPTION OF THE DRAWINGS

The present invention will be described further, by way of example only, with reference to embodiments thereof as illustrated in the accompanying drawings, in which:

FIG. 1 schematically illustrates a system in accordance with a number of examples;

FIG. 2 schematically illustrates a number of examples in which the RAMs take the form of TAGE tables;

FIG. 3 illustrates an example of the contents of the indication circuitry;

FIG. 4 illustrates a flowchart that shows a process of querying in accordance with some examples;

FIG. 5 shows a variant of the system in which the indication circuitry communicates with a level two indication circuitry;

FIG. 6 illustrates the update process that takes place when new data is added to the storage circuits;

FIG. 7 shows a typical cycle of training/non-training;

FIG. 8 illustrates an example in which the indication circuitry 10 is extended to contain a time parameter; and

FIG. 9 shows one or more packaged chips, with the apparatus implemented on one chip or distributed over two or more of the chips.

### DESCRIPTION OF EXAMPLE EMBODIMENTS

Before discussing the embodiments with reference to the accompanying figures, the following description of embodiments is provided.

In accordance with one example configuration there is provided a data processing apparatus comprising: a plurality of storage circuits, each configured to store data items in association with tags; indication circuitry configured to indicate, for a partial tag that is provided as an input, a subset of the storage circuits where the partial tag is part of the tags stored in that storage circuit, and to cause the subset of the storage circuits to be powered to a power level at which the subset of the storage circuits can be accessed; and access circuitry configured to search the subset of the storage circuits for a tag comprising the partial tag once the indication circuitry has caused the subset of storage circuits to be powered.

By using the indication circuitry it is possible in many cases to power a subset of the storage circuits (rather than all of them) in order to access a data item that is associated with a tag. In this way it is possible to save power as compared to a situation when each of the storage circuits is powered so as to allow access. In order to achieve this, a partial tag is used to perform a search in the indication circuitry. The partial tag only contains part of the full tag for which a data item is sought. The indication circuitry then returns a subset of the storage circuits, with the subset listing each of the storage circuits that could contain a data item whose tag contains the partial tag. This therefore includes storage circuits that contain data items with tags that are not sought by the current query. It is desirable for the subset of storage circuits that is returned to contain each of the storage circuits that contains data corresponding to the currently sought tag. However, the subset may also contain references to storage circuits that do not contain data corresponding to the current sought tag. Note that it is not necessary for every entry of the indication circuitry to list a strict subset of the storage circuits. For instance, some entries may list the full set of storage circuits in their entirety. In some examples, a capacity of the indication circuitry is lower than a capacity than each of the plurality of storage circuits. By having a smaller capacity for the indication circuitry than the storage circuits, it is more efficient to use the indication circuitry than it is to search the storage circuit or circuits. Furthermore, since the indication circuitry is comparatively smaller, it is better able to meet the timing requirements found within the pipeline.

In some examples, the tag is used to generate an index at which the data is stored; and the partial tag is made from a subset of bits of the tag. The tag could be used to generate an index, e.g. by performing a hash of the tag. The partial tag may only contain a (strict) subset of the bits that are used in the tag, or may be generated using a (strict) subset of the bits that are used in the tag. For instance, the tag may be made up by combining or hashing a number of different elements while the partial tag may only be made up by combining or hashing some of those elements. If a hashing algorithm is used to generate the tag then either the same or a different hashing algorithm can be used to generate the index.

In some examples, the indication circuitry is configured to determine one or more indices from the partial tag, and to use the one or more indices to index into a probabilistic data structure in order to determine the subset of the storage circuits. An example of a probabilistic data structure is a bloom filter, which can be used to determine set membership. A bloom filter is such that it is possible to determine whether a given data value might be in the bloom filter or is definitely not in the bloom filter. For example, one bloom filter might be provided per storage circuit to indicate if that storage circuit should be powered for a given partial tag.

In some examples, the tags comprise at least part of a program counter value and a state of the data processing apparatus; and the partial tag comprises at least a subset of the at least part of the program counter value. The state of the data processing apparatus can be a representation of an execution path that the data processing apparatus has taken to reach its current state. By considering the state together with the program counter value in a (full) tag, it is possible to differentiate between different instances of a same program instruction in a set of instructions. Meanwhile, by considering only the program counter value (or part of it) for the partial tag, it is possible to identify entries relating to each instance of an instruction.

In some examples, the state of the data processing apparatus is at least part of a series of control flow instruction outcomes. In some examples, the state comprises the outcome(s) of a series of control flow instructions. This series therefore not only distinguishes between different ways in which an instruction can be been reached but also different instances of an instruction as may be found in a loop or iterative function. The state need not cover the entire history of control flow instructions and indeed in some examples, different storage circuits may generate indexes based on different lengths of the most recent control flow instructions.

In some examples, each of the plurality of storage circuits stores a history table of a TAGE predictor. A TAGE predictor is used to perform predictions for instructions and is made up from a number of tables. A base table provides predictions based solely on the program counter value of an instruction. Other tables add varying lengths of history such as control flow history (e.g. as is provided in a global history register) to the program counter value in order to provide tags, which are used to access the storage circuits. This not only helps to differentiate between different instances of instructions but also recognises that the behaviour of any given control flow instruction is likely to be affected by the behaviour of preceding control flow instructions that lead up to the current point. In general, the table containing a prediction that uses the largest input will produce the most accurate prediction. For instance, a prediction made for the current program counter value and the last three control flow instructions is considered to be less accurate that a prediction made for the current program counter value and the last ten control flow instructions (assuming that such a prediction actually exists in the table). A difficulty with a TAGE prediction is that it requires a large amount of storage, which in turn consumes a large amount of power in order to activate all of the storage circuits to search each of them. Using the present technique, it is possible to only activate and search those of the storage circuits that are likely to have relevant entries. For instance, for a given program counter value, the indication circuitry may indicate that only history tables 0 and 1 contain relevant entries – that is, only those history tables contain any entries with the current program counter value (irrespective of the amount of execution context provided). Thus, it is possible to only activate and search those tables and if the histories in those tables match the current execution history then the prediction can be returned. Power is therefore saved from not having to activate other TAGE tables. The timing requirements are also met here because the indication circuitry does not require any history, but instead uses program counter bits. In other examples, the plurality of storage circuits could form a hierarchy of data caches (e.g. a level one data cache, a level two data cache, etc.) with the indication circuitry being used to guide where a memory access query should be directed (e.g. which cache), in order to both improve latency from sequential querying and also to save power consumption from needlessly querying caches where a miss will occur.

In some examples, in response to a miss in the indication circuitry, the indication circuitry is configured to cause each of the storage circuits to be powered to the power level at which the subset of the storage circuits can be accessed, and the access circuitry is configured to search each of the storage circuits for the tag. If a miss occurs in the indication circuitry, then this is indicative that there is no information regarding which of the storage circuits the tag appears in. Consequently, each of the storage circuits can be powered up and searched. The resulting information regarding the source of the storage circuit(s) that hit (if any) can then be added to the indication circuitry as appropriate so that the information is available for a future query.

In some examples, the data processing apparatus comprises: level two indication circuitry having a higher capacity than the indication circuitry; and in response to a miss occurring in the indication circuitry, the level two indication circuitry is searched and when there is a hit on a hitting entry, the hitting entry is transferred to the indication circuitry. In these examples, a two-layer indication system is provided. Where a miss occurs in the (level one) indication circuitry, the level two indication circuitry can be searched and any relevant values (e.g. values having the partial tag) can be returned and inserted into the (level one) indication circuitry for a future query to be able to access. In some examples, this still results in a miss due to timing constraints and so the immediate query may still result in all storage circuits being powered up and accessed. However, the insertion of data into the (level one) indication circuitry makes it available for use in a subsequent iteration.

In some examples, the level two indication circuitry is a base table in which the tags are matched against the partial tag in isolation.

In some examples, the level two indication circuitry is a base table of a history-based predictor. The level two indication circuitry could be one of the storage circuits – specifically one that uses partial tags as tags. In a TAGE predictor, for instance, a base table is used to store data items against tags where only the program counter makes up the tags. That is, none of the history is used.

In some examples, in response to the level two indication circuitry being updated with an identity of the one of the storage circuits, the indication circuitry is updated to remove each entry whose partial tag in the indication circuitry is a partial tag of the new tag. Consequently, the next time a search is carried out for the partial tag, it will miss in the (level one) indication circuitry, causing the updated data to be acquired from the level two indication circuitry.

In some examples, a behaviour of the indication circuitry is divided into a training period followed by a non-training period; and in response to an end of the non-training period, the indication circuitry is reset. The non-training period lasts for a certain length of time. This is because of the expectation that over time, the indication circuitry may increasingly produce results that suggest activating all storage circuits, which reduces the usefulness of the indication circuitry. This is particularly true where evictions from the storage circuits occurs silently. In order to address this, when the non-training period ends, the relevant entry or entries in the indication circuitry are reset (e.g. deleted or invalidated) and new up-to-date entries can be stored in their place. Note that the reset may not be a complete reset of the indication circuitry – only some of the entries that are stored could be reset at the end of the training period (as will be described below). In some examples, the training period and the non-training period are defined according to a number of processor cycles. In other examples, the non-training period may be defined based on a calendar time (e.g. a number of milliseconds). In other examples, the non-training period and training period may not be fixed but might instead be linked to performance. For instance, if training is proving to have been successful (no new information is being added) then training might end and if querying is resulting in each query causing each storage circuit to be activated then the non-training period might come to an end with a reset.

In some examples, the training period and the non-training period are defined for each entry of the indication circuitry. The training period and the non-training period could therefore be independent for each entry of the indication circuitry. In other words, training for one partial tag might be taking place while another partial tag is being reset and another partial tag is being queried. Each entry can therefore be trained on an individual basis. This makes it possible to maintain some usefulness of the indication circuitry even though training may still be taking place.

In some examples, the data items comprise predictions of instruction behaviour; and the data processing apparatus comprises update circuitry configured to update the subset of the storage circuits stored for the partial tag in response to those of the predictions returned by the access circuitry during the non-training period causing a misprediction. Thus, during the non-training period, when a misprediction occurs using the data that is returned, the update circuitry causes the subset of storage circuits for that period tag to be updated. For instance, the subset of storage circuits may be expanded by performing a logical OR on the original subset and the set of the storage circuits for which a hit occurs. A misprediction may occur either because a better prediction was available in a storage circuit that was not powered up and searched, or that a particular prediction is simply unreliable. In either case, this may cause new data to be added to the storage circuits, which in turn may cause updating/expanding of the subset of the storage circuits for the partial tag to include those of the storage circuits that are subsequently determined to hold relevant data.

In some examples, during the training period, the indication circuitry is configured to indicate the plurality of storage circuits as the subset of the storage circuits, regardless of the input. During the training period, the empty set is returned by the indication circuitry for each request (regardless of what is stored in the indication circuitry) thereby causing each of the storage circuits to be powered up in order to be searched for the relevant tags. The set of storage circuits for which a hit occurs is then stored in the indication by performing a logical OR’d with any existing entry. Once the training period has ended, and the non-training period begins, the true results stored in the indication circuitry are returned for each search.

In some examples, in response to a particular one of the storage circuits having data in association with a particular tag, the indication circuitry is updated to reference the particular one of the storage circuits for each partial tag in the indication circuitry that is a partial tag of the particular tag. This addition process might be limited to just the training period (if it exists) or may be permitted at all times. Regardless, if new data is added to a storage circuit that was previously not part of the subset of storage circuits for a given partial tag, then the subset can be updated. Meanwhile if there is an existing entry for a partial tag, and it is newly determined that another storage circuit (not in the subset) contains a tag comprising the partial tag, then the entry can be expanded to include the another storage circuit. For instance, in the case of a TAGE predictor, it may be that a new prediction is added for a new length of branch predictor history. In this situation, the subset is updated so that in the future when the same partial tag is presented, the storage circuit containing the new data will also be listed in the subset.

In some examples, in response to one of the storage circuits gaining data in association with a new tag, the indication circuitry is updated to remove each partial tag in the indication circuitry that is a partial tag of the new tag. Thus, when new data is added, the entry in the indication circuitry is deleted. This means that next time the same partial tag is provided, a miss will occur. This then causes all of the storage circuits to be powered up and searched and the hit mask (the set of storage circuits for which a hit occurs on the full tags) can then be stored alongside the partial tag in the indication circuitry for the future. As above, this addition process may occur solely during the training period or could occur at any time.

Particular embodiments will now be described with reference to the figures.

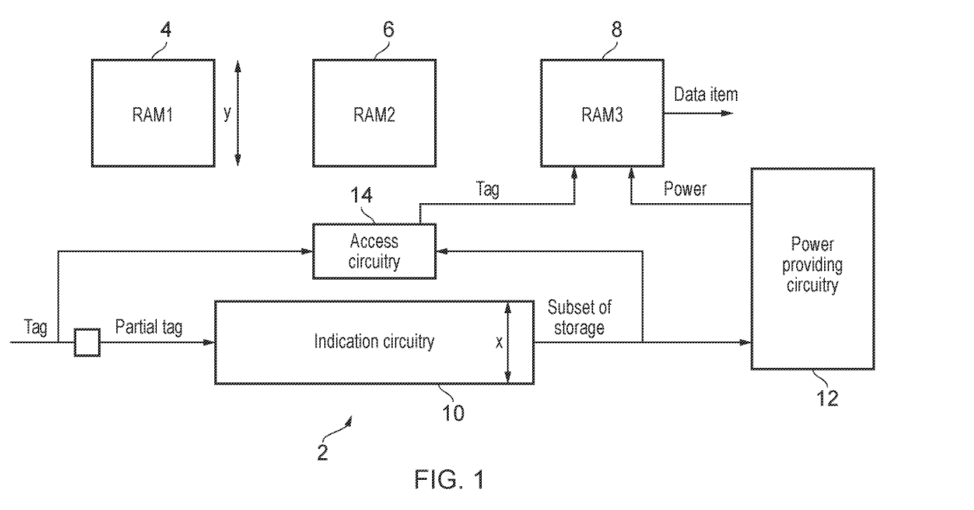

FIG. 1 schematically illustrates a system 2 in accordance with a number of examples. Within the system, a number of RAMs 4, 6, 8 are provided, which are examples of the claimed storage circuitry. In some examples, these RAMs 4, 6, 8 might be caches. Regardless, each of the RAMs 4, 6, 8 is such that it provides a plurality of mappings between tags and data items. That is, a particular data item can be returned from a given RAM 4 as a consequence of providing the tag for that data item that is stored in that RAM 4.

A difficulty that arises here is that each of the RAMs 4, 6, 8 might consume power in order to be powered up and in order to be searched for the data item corresponding to a particular tag (which might not even be present in many cases). To help resolve this, indication circuitry 10 is provided, which is able to provide a prediction as to which of the RAMs 4, 6, 8 should be powered up (via power providing circuitry 12) in order for the indicated RAM 4, 6, 8 to be searched (via access circuitry 14).

Once a tag is determined for a data item, it is passed to the access circuitry 14. In addition, at least a part of the tag is used to create a partial tag, which is passed to the indication circuitry 10. The partial tag might be generated by only including a subset of the bits of the (full) tag. The indication circuitry then looks through its entries for any entry that corresponds to the partial tag. Where an entry is found, a subset 8 of the RAMs 4, 6, 8 is indicated. Those storage circuits 8 are powered up to such an extent that they can be searched by the power providing circuitry 12. The subset 8 is also passed to the access circuitry 14, which is then able to access the powered up RAMs 8 to provide the requested data items. The storage circuits 4, 6 that are outside the subset 8 are maintained in a low power mode where searching and/or returning of specific data items cannot be performed.

Note that the term ‘subset’ here need not be a strict subset. In most cases, a strict subset of the storage circuits 4, 6, 8 will be returned, since it is the returning of a strict subset that enables the power consumption to be lowered. Nevertheless, there are occasions (as will be explained in more detail below) where a strict subset is not returned.

In this example the storage capacity of the indication circuitry 10 (x) is lower than the storage capacity (y) of each of the storage circuits 4, 6, 8. In some examples, the storage capacity of the indication circuitry 10 (x) is lower than the storage capacity of the total capacity of each of the storage circuits so that it requires less power to search the indication circuitry 10 than all of the storage circuits 4, 6, 8.

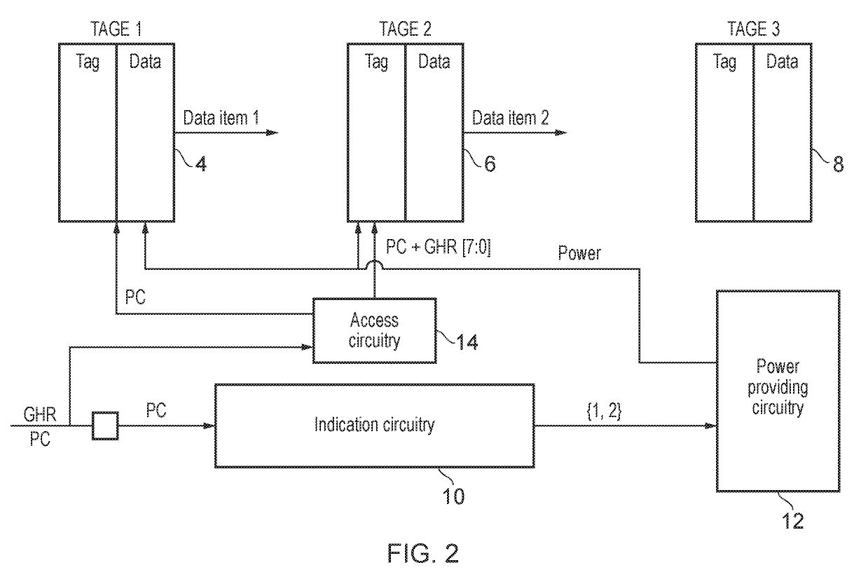

FIG. 2 schematically illustrates a number of examples in which the RAMs 4, 6, 8 take the form of TAGE tables. A TAGE predictor is a form of history-based predictor, which can be used (for instance) for branch prediction or for data value prediction. One feature of the TAGE predictor is that each table tags entries with different amounts of execution state. A given instruction could therefore have multiple entries and even the same instance of an instruction might have entries in each table – each tagged with a different quantity of execution state. This makes it possible to not only differentiate between different instances of the same instruction but also different circumstances in which the same instruction might be executed, which can enable more accurate predictions to be made.

In this example, the state of the data processing apparatus is produced by a Global History Register (GHR), which may take the form of a register that tracks the most recent N outcomes of branch instructions (i.e. taken or not taken). Entries in the TAGE predictor tables indicate the prediction that is to be made for a given instruction with a given history of a given length – with the length differing between each table. A given instruction may appear multiple times in the tables – with a different length of history in each table. For instance, a given instruction may be tagged using only the program counter and zero bits of the GHR (in a first base table), the program counter value of the instruction plus eight bits of history (in a second table), and the program counter value of the instruction plus 24 bits of history (in a third table). When a prediction is sought, the table having an entry for the given instruction with the longest history that matches the current history is used. So a result that matches the program counter value and the most recent 24 entries of the GHR is considered to be more accurate than a result that matches only the program counter value. Nevertheless, the entry that matches only the program counter value may still be correct and so cannot be ignored until it is known whether a result will hit in the other TAGE tables.

A challenge with applying the present technique to TAGE predictors is that TAGE prediction is timing sensitive. This therefore makes it impractical to use full TAGE tags in the indication circuitry 10. In addition, there would be a large number of entries since each instance of each instruction might have one or more entries per table. This would therefore require a large amount of storage circuitry. However, merely using the program counter value is problematic because, as explained above, there may be multiple entries for one program counter value. The present technique solves this by the concept of ‘stickiness’. In particular, if TAGE table Z contains an entry whose tag is made up of a program counter value and any branch history, then TAGE table Z is listed within the subset associated with that program counter value (as the partial tag) in the indication circuitry 10. The partial tag therefore covers storage circuits that could be activated for any full tag that contains the partial tag. The entry is sticky because once set it stays set (until the entry is cleared).

In the example of FIG. 2, the PC is passed to the indication circuitry 10, which in these examples does not use any quantity of the GHR to return the subset of TAGE tables 4, 6, 8. In this example, the subset of TAGE tables is only the first TAGE table 4 and the second TAGE table 6. These indications are passed to the power providing circuitry 12, which as in FIG. 1, causes the specified TAGE tables 4, 6 to be activated such that they can be searched. The access circuitry 14 then uses the PC and differing amounts of the GHR to access each of the activated TAGE tables 4, 6. For instance, an access to the second TAGE table 6 is achieved by using the first eight bits (0 to 7) of the GHR while an access to the first TAGE table 4 does not use any bits of the GHR.

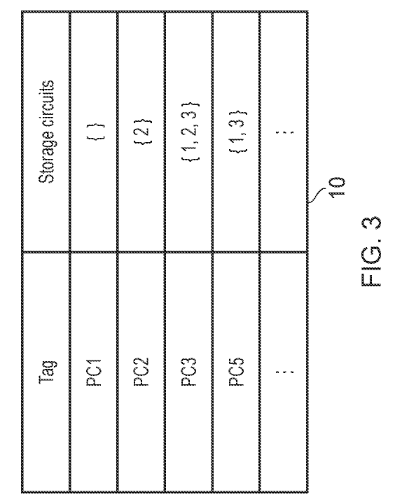

FIG. 3 illustrates an example of the contents of the indication circuitry 10. Here, there are provided a number of entries, with each of the entries providing a mapping from a tag to an indication of a subset of the storage circuits. For instance, the tag PC1 provides the empty set, which is to say that the data associated with any tag of which PC1 is a part of that tag is not believed to be held in any of the storage circuits 4, 6, 8. As another example, if the tag PC2 is provided, then the indication circuitry 10 provides the indication that there is some corresponding data believed to be held in the second storage circuit. The indicated storage circuits can then be powered and searched with other storage circuits being depowered, or placed into a low power mode in order to provide a power reduction as compared to all circuits running continually.

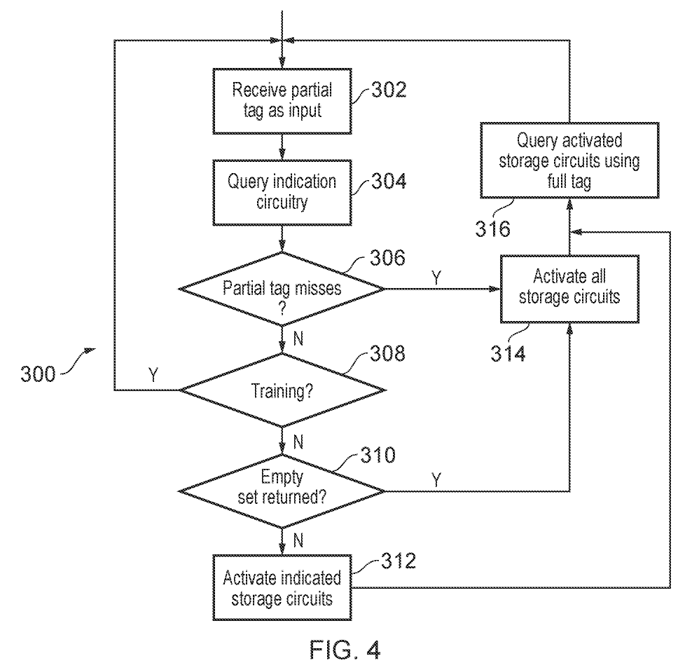

FIG. 4 illustrates a flowchart 300 that shows a process of querying in accordance with some examples. The process begins at step 302 where a partial tag is received as an input at the indication circuitry 10. Using this partial tag, the indication circuitry 10 is queried at step 304. It is then determined whether the query misses at step 306. If so, then all the storage circuits are activated at step 314. They are then queried at step 316 and the process returns to the beginning. This represents the situation where the indication circuitry 10 has no knowledge of the requested tag. That is to say that the storage circuits 4, 6, 8 might or might not contain relevant data. The appropriate response, therefore, is to activate each of the storage circuits 4, 6, 8 in order to search them. The result of this searching can then be returned back to the indication circuitry 10 in order to store the indication for a future query.

If the partial tag does not miss at step 306 (i.e. there is a hit in the indication circuitry 10) then at step 308, it is determined whether the system is in a training mode or not. If so, then all the storage circuits are activated at step 314 and searched at step 316. This represents the fact that during the training mode (described in more detail below), the actual results of the indication circuitry 10 are not used while the data is built up. If the system is not in a training mode, then at step 310 it is determine whether the empty set is returned. If so, the prediction is that none of the storage circuits 4, 6, 8 contains data corresponding to the partial tag and so the process returns to the start. Otherwise at step 312, those of the storage circuits 4, 6, 8 that are indicated by the query are activated and at step 316, they are searched using the full tag.

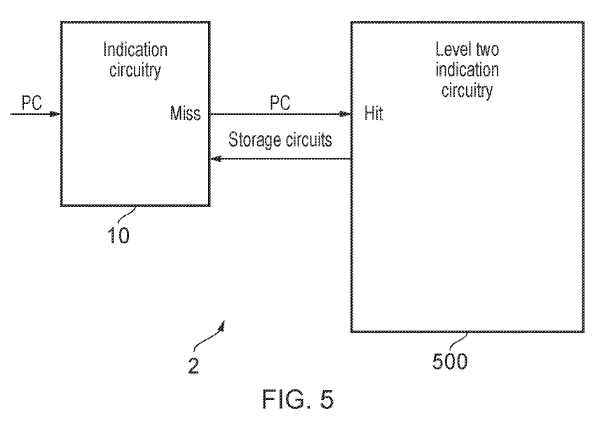

FIG. 5 shows a variant of the system 2 in which the indication circuitry 10 communicates with a level two indication circuitry 500. In these examples, the level two indication circuitry 500 is bigger than the indication circuitry 10 and is used to store a larger set of entries than the indication circuitry 10 in a similar manner to a cache hierarchy, for instance. In these examples, each time an entry is added to the indication circuitry 10, it is also added to the level two indication circuitry 500. When a miss occurs in the indication circuitry 10, the level two indication circuitry 500 is queried using the same partial tag (e.g. the PC value). If a hit occurs in the level two indication circuitry 500 then the indication of the resulting set of storage circuits that is stored with that partial tag is returned and stored in the indication circuitry 10 and this can then be returned in response to the original query. A victim must be selected from the indication circuitry 10 in order to be replaced, and this victim can be moved into the level two storage circuitry 500. Note that in some embodiments, if there is a hit in the level two indication circuitry 500, the storage circuits 4, 6, 8 are kept powered until the data is returned. At that point, the storage circuits 4, 6, 8 may be powered down as indicated by the returned data.

If a miss occurs in the level two indication circuitry, then all of the storage circuits 4, 6, 8 may be activated and searched as previously described – with the resulting hits in the storage circuits 4, 6, 8 then being stored to the indication circuitry against a partial version of the tag.

Note that in this example, since the level two indication table 10 is essentially acting as a modified TAGE base table 4 (i.e. one that does not use the GHR), in some examples, the TAGE base table 4 could be used as the level two indication table 10. The lookup/allocation policy of TAGE could then be changed such that the history levels (TAGE tables 6, 8 that use the GHR) are not accessible unless there is already a corresponding entry in the base TAGE table 4. This reduces the effective capacity of the predictor for constant value loads. Without this modification, it is considered that it is sufficiently rare that there will be no base TAGE table 4 that the effect on power consumption is expected to be low or negligible. In a simple implementation, the indication circuitry uses X bits to store its data for each entry (e.g. the number of memory banks used for each history table/length multiplied by the number of different history table lengths). Where the base table 4 is used as the level two indication table 10, those X bits can be added to each entry of the base table 4.

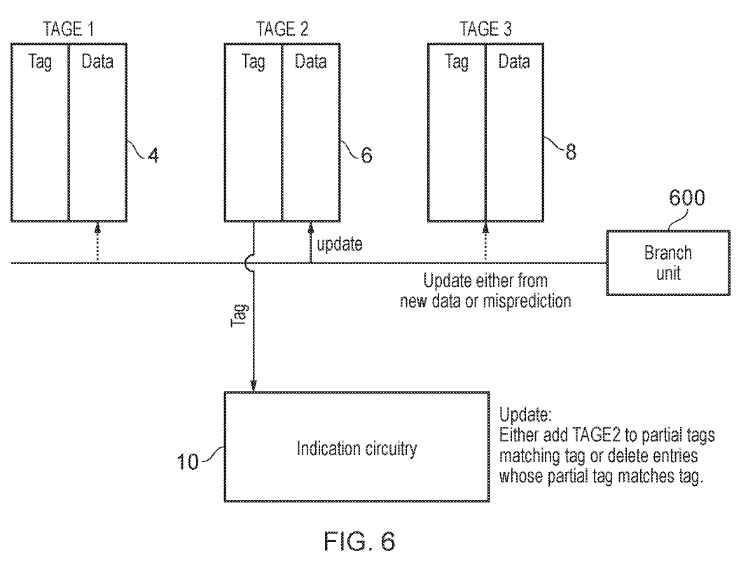

FIG. 6 illustrates the update process that takes place when new data is added to the storage circuits 4, 6, 8. New data may be added to the storage circuits 4, 6, 8 for a number of reasons. Firstly, a misprediction might occur. A misprediction is a result of prediction circuitry 4, 6, 8 producing a prediction for data that turns out to be incorrect. In this situation, when the instruction is properly executed, the misprediction will be detected and a correction will be sent back to the prediction circuitry. Secondly, new data may simply arise as a consequence of data not having been previously available. For instance, if data was not previously available for a particular tag then no prediction may be available. In this situation, once the instruction is executed, the outcome will be known and this can be provided to the prediction circuits 4, 6, 8 in order to be available for a later instance of the instruction. In either case, the set of prediction circuitry 4, 6, 8 that contain relevant data for the partial tag can be determined and updated in the indication circuitry 10.

In the example illustrated in FIG. 6, the prediction is detected by the execution of an instruction using a branch unit 600. This assumes that the prediction circuits are making predictions in respect of branch instructions. Where predictions are made in respect of data value predictions, for instance, new predictions (or mispredictions) could be detected by, for instance, a load/store unit that handles accesses to/from a main memory.

In this example, the branch unit provides details of the branch that took place. An update is then made to the relevant predictors or RAMs 4, 6, 8 based on the current status of the data processing circuitry. For instance, if a misprediction is being notified, then those entries that were relied upon to make the prediction are updated. In the case of TAGE, this might be expected to be in the table or RAM 4, 6, 8 having a hit against a tag that is made up of the program counter value of the branch instruction and the longest portion of the GHR. Where a misprediction is not occurring – i.e. where new prediction data is being loaded, then this would involve updating each of the TAGE tables 4, 6, 8 for the same program counter value and different subsets of the GHR. For instance, the first TAGE table 4 might be updated using only the program counter value, the second TAGE table 6 might be updated using a tag of the program counter value and the first 8 bits of the GHR and the third TAGE table 8 might be updated using a tag of the program counter value and all of the bits of the GHR.

The exact process is not material to the present invention and is dependent on the mechanism being used to the store the data in the tables 4, 6, 8. What is important is that the tag or tags of the newly added data is then provided to the indication circuitry 10 (e.g. via a logical OR of any existing entry) and this is used to update the indication circuitry 10 by forming one partial tag from the tags and updating or adding an entry in the indication circuitry that indicates those of the storage circuits/RAMs/tables 4, 6,8 that have newly added data. An update can be achieved in at least two ways. The first way is to simply update any existing entry so that it contains both the old data and the new data. The second way is to delete any existing entry. This will cause a miss in the next access, which will in turn cause all of the storage circuits 4, 6, 8 to be activated and searched and then for the indication circuitry 10 to be updated with those of the storage circuits that hit.

A problem that can arise is that over time, entries will be evicted from the storage circuits 4, 6, 8. Without any notification mechanism being provided to the indication circuitry 10, this will eventually result in each storage circuitry ‘hitting’ for each tag – causing each storage circuit 4, 6, 8 to be activated for each tag. This reduces the opportunities to power down the storage circuits 4, 6, 8. In order to help with this, entries in the indication circuitry 10 are periodically reset or erased. A training period then takes place in which the relevant entries in the indication circuitry 10 are not used to decide which storage circuits 4, 6, 8 should be powered and accessed and instead, each of the storage circuits 4, 6, 8 are powered and accessed. A hit mask is then formed, which indicates those of the storage circuits 4, 6, 8 in which a hit occurs for a tag containing the partial tag. This hit mask is logically OR’d with any existing entry for the partial tag in the indication circuitry 10. Consequently, over the training period, it is anticipated that the indication circuitry 10 will come to learn of each of the storage circuits 4, 6, 8 that hits for any tag containing a given partial tag. That subset of the storage circuits 4, 6, 8 can then be stored against the given partial tag in the indication circuitry 10. In some examples, the hit mask is configured to only indicate the storage circuit 4, 6, 8 that hit that uses the largest amount of history (on the assumption that such an entry will contain the best prediction).

Another type of update that might occur is if the indication circuitry 10 lists a storage circuit as containing relevant data, but a miss occurs on the full tag for the specified storage circuit. In this situation, the set of storage circuits 4, 6, 8 for which hits occur will differ from the subset of storage circuits returned by the indication circuitry 10 and here it is possible for the entry of the indication circuitry 10 to be updated to correspond with the set of storage circuits in which a hit occurs.

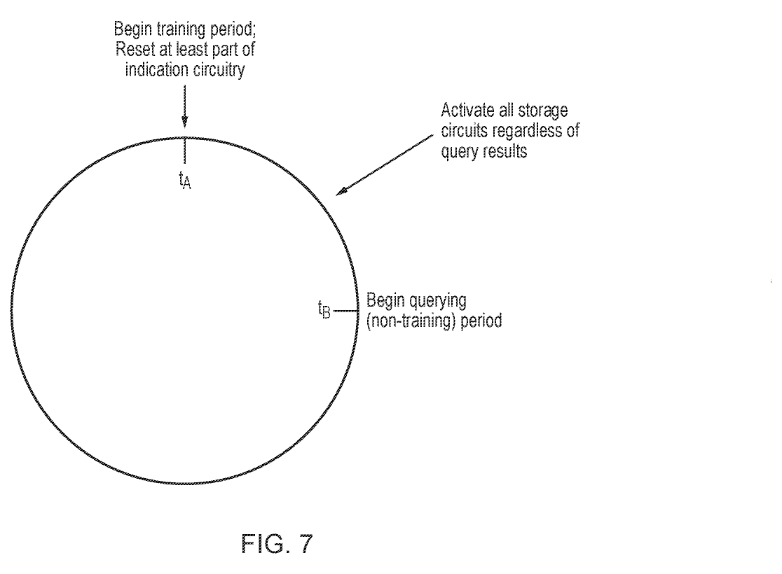

FIG. 7 shows a typical such cycle. At a time t_{A}, a training period begins and the relevant entries of the indication circuitry 10 (which may be all of them) are cleared. During the training period, the indication circuitry 10 is still queried, but regardless of the storage circuits 4, 6, 8 that it indicates should contain an entry whose tag contains the partial tag, all of the storage circuits are powered up and searched in order to determine the full set of storage circuits that apply to each partial tag. At a time t_{B}, the training period ends. From this point forward, only those storage circuits containing data items with a tag that contains the partial tag are powered up and searched. That is, the results of the indication circuitry 10 are then used. This non-training period lasts for a period of time until such time as a new training period begins at t_{A} and the process then repeats.

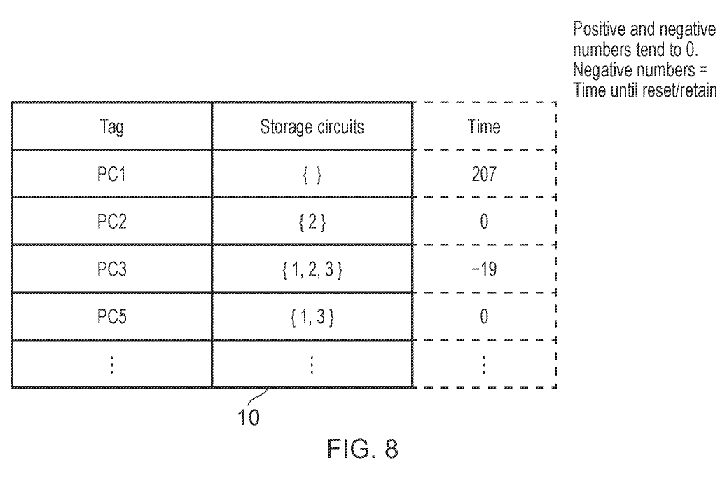

The training process can take part on behalf of all entries in the indication circuitry 10 at the same time. But this need not be the case. FIG. 8 illustrates an example in which the indication circuitry 10 is extended to contain a time parameter, which can be used to indicate how long until the next phase (training or non-training) is entered into for that particular entry. For instance, for the entry with tag PC1, the time is listed as ‘207’ meaning that in 207 units of time (e.g. ms), the training period will end. The entry associated with PC3 is negative, meaning that this is time until the non-training period ends. That is, in 19 units of time (e.g. ms), the non-training period will end. This will cause the PC3 entry to be reset or deleted and for it to enter a training period once more.

Other training techniques are of course also possible. For instance, in some examples, two training periods are provided one after another (with a reset occurring only at the start of the first training period). A particular entry (i.e. program counter value) that is seen in both the first training period and the second training period is kept during the non-training period. The subset of storage circuits 4, 6, 8 for the entry may be the logical OR of the storage circuits 4, 6,8 that hit in the first training period and the storage circuits 4, 6, 8 that hit in the second training period. Alternatively, inclusion during the non-training period might require the same subset of storage circuits to be provided for the same entry during both the first training period and the second training period.

Accordingly, the above description provides a way in which indication circuitry can be used in order to reduce the power consumption of looking up entries in storage circuits. This is of particular use in TAGE where a large number of lookup tables exist.

The examples above have primarily been concerned with situations where the storage circuits 4, 6, 8 and prediction circuits such as with TAGE. However, the same technique could also be used with other storage circuits. For instance, a similar mechanism could be used to predict whether particular data was stored in a level one data cache, a level two data cache, or a level three data cache with the data caches being powered down when not needed. This makes it possible to inhibit all three caches from being repeatedly powered up in order to be searched. Instead, powering up can be limited to those of the storage circuits 4, 6, 8 that are predicted to be needed. Clearly the number of storage circuits provided for use with the present technique can differ from the three storage circuits 4, 6, 8 that are shown here.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

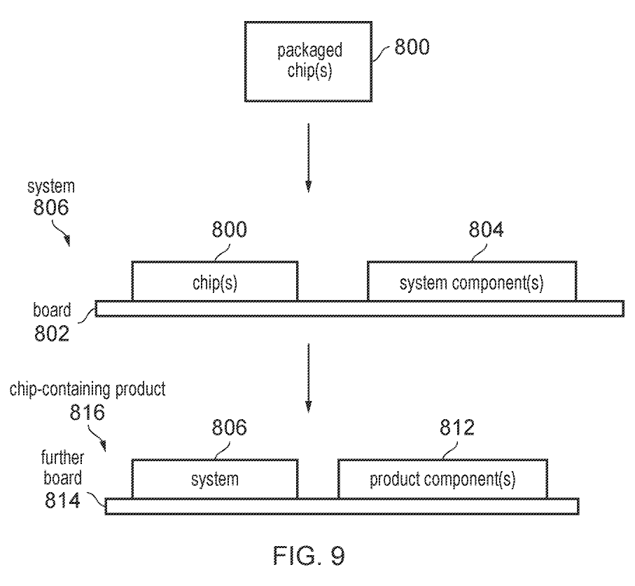

As shown in FIG. 9, one or more packaged chips 800, with the apparatus described above implemented on one chip or distributed over two or more of the chips, are manufactured by a semiconductor chip manufacturer. In some examples, the chip product 800 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 800 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 800 are assembled on a board 802 together with at least one system component 804 to provide a system 806. For example, the board may comprise a printed circuit board. The board substrate may be made of any of a variety of materials, e.g. plastic, glass, ceramic, or a flexible substrate material such as paper, plastic or textile material. The at least one system component 804 comprise one or more external components which are not part of the one or more packaged chip(s) 800. For example, the at least one system component 804 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 816 is manufactured comprising the system 806 (including the board 802, the one or more chips 800 and the at least one system component 804) and one or more product components 812. The product components 812 comprise one or more further components which are not part of the system 806. As a non-exhaustive list of examples, the one or more product components 812 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 806 and one or more product components 812 may be assembled on to a further board 814.

The board 802 or the further board 814 may be provided on or within a device housing or other structural support (e.g. a frame or blade) to provide a product which can be handled by a user and/or is intended for operational use by a person or company.

The system 806 or the chip-containing product 816 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In the present application, the words “configured to…” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

### Embodiments could be configured as follows:

1. A data processing apparatus comprising: a plurality of storage circuits, each configured to store data items in association with tags; indication circuitry configured to indicate, for a partial tag that is provided as an input, a subset of the storage circuits where the partial tag is part of the tags stored in that storage circuit, and to cause the subset of the storage circuits to be powered to a power level at which the subset of the storage circuits can be accessed; and access circuitry configured to search the subset of the storage circuits for a tag comprising the partial tag once the indication circuitry has caused the subset of storage circuits to be powered.

2. The data processing apparatus according to clause 1, wherein

the tag is used to generate an index at which the data is stored; and

the partial tag is made from a subset of bits of the tag.

3. The data processing apparatus according to any preceding clause, wherein

the indication circuitry is configured to determine one or more indices from the partial tag, and to use the one or more indices to index into a probabilistic data structure in order to determine the subset of the storage circuits.

4. The data processing apparatus according to any preceding clause, wherein the tags comprise at least part of a program counter value and a state of the data processing apparatus; and

the partial tag comprises at least a subset of the at least part of the program counter value.

5. The data processing apparatus according to clause 4, wherein

the state of the data processing apparatus is at least part of a series of control flow instruction outcomes.

6. The data processing apparatus according to any preceding clause, wherein

each of the plurality of storage circuits stores a history table of a TAGE predictor.

7. The data processing apparatus according to any preceding clause, wherein

in response to a miss in the indication circuitry, the indication circuitry is configured to cause each of the storage circuits to be powered to the power level at which the subset of the storage circuits can be accessed, and the access circuitry is configured to search each of the storage circuits for the tag.

8. The data processing apparatus according to any preceding clause, comprising:

level two indication circuitry having a higher capacity than the indication circuitry; and

in response to a miss occurring in the indication circuitry, the level two indication circuitry is searched and when there is a hit on a hitting entry, the hitting entry is transferred to the indication circuitry.

9. The data processing apparatus according to any preceding clause, wherein

the level two indication circuitry is a base table in which the tags are matched against the partial tag in isolation.

10. The data processing apparatus according to any preceding clause, wherein

the level two indication circuitry is a base table of a history-based predictor.

11. The data processing apparatus according to any one of clauses 8-10, wherein

in response to the level two indication circuitry being updated with an identity of the one of the storage circuits, the indication circuitry is updated to remove each entry whose partial tag in the indication circuitry is a partial tag of the new tag.

12. The data processing apparatus according to any preceding clause, wherein

a behaviour of the indication circuitry is divided into a training period followed by a non-training period; and

in response to an end of the non-training period, the indication circuitry is reset.

13. The data processing apparatus according to clause 11, wherein

the training period and the non-training period are defined for each entry of the indication circuitry.

14. The data processing apparatus according to any one of clauses 12-13, wherein

the data items comprise predictions of instruction behaviour; and

the data processing apparatus comprises update circuitry configured to update the subset of the storage circuits stored for the partial tag in response to those of the predictions returned by the access circuitry during the non-training period causing a misprediction.

15. The data processing apparatus according to any one of clauses 12-14, wherein

during the training period, the indication circuitry is configured to indicate the plurality of storage circuits as the subset of the storage circuits, regardless of the input.

16. The data processing apparatus according to any preceding clause, wherein

in response to particular one of the storage circuits having data in association with a particular tag, the indication circuitry is updated to reference the particular one of the storage circuits for each partial tag in the indication circuitry that is a partial tag of the particular tag.

17. A system comprising:

the data processing apparatus of any preceding clause, implemented in at least one packaged chip;

at least one system component; and

a board, wherein

the at least one packaged chip and the at least one system component are assembled on the board.

18. A chip-containing product comprising the system of clause 17, wherein the system is assembled on a further board with at least one other product component.

19. A data processing method comprising:

storing data items in association with tags in a plurality of storage circuits;

indicating, for a partial tag that is provided as an input, a subset of the storage circuits where the partial tag is part of the tags stored in that storage circuit;

causing the subset of the storage circuits to be powered to a power level at which the subset of the storage circuits can be accessed; and

searching the subset of the storage circuits for a tag comprising the partial tag once the subset of storage circuits have been powered.

20. A non-transitory computer-readable medium storing computer-readable code for fabrication of the data processing apparatus of clause 1.

We claim:

1. A data processing apparatus comprising:
a plurality of storage circuits, each configured to store data items in association with tags;
indication circuitry configured to indicate, for a partial tag that is provided as an input, a subset of the storage circuits where the partial tag is part of the tags stored in that storage circuit, and to cause the subset of the storage circuits to be powered to a power level at which the subset of the storage circuits can be accessed; and
access circuitry configured to search the subset of the storage circuits for a tag comprising the partial tag once the indication circuitry has caused the subset of storage circuits to be powered.

2. The data processing apparatus according to claim 1, wherein
the tag is used to generate an index at which the data is stored; and
the partial tag is made from a subset of bits of the tag.

3. The data processing apparatus according to claim 1, wherein
the indication circuitry is configured to determine one or more indices from the partial tag, and to use the one or more indices to index into a probabilistic data structure in order to determine the subset of the storage circuits.

4. The data processing apparatus according to claim 1, wherein
the tags comprise at least part of a program counter value and a state of the data processing apparatus; and
the partial tag comprises at least a subset of the at least part of the program counter value.

5. The data processing apparatus according to claim 4, wherein
the state of the data processing apparatus is at least part of a series of control flow instruction outcomes.

6. The data processing apparatus according to claim 1, wherein
each of the plurality of storage circuits stores a history table of a TAGE predictor.

7. The data processing apparatus according to claim 1, wherein
in response to a miss in the indication circuitry, the indication circuitry is configured to cause each of the storage circuits to be powered to the power level at which the subset of the storage circuits can be accessed, and the access circuitry is configured to search each of the storage circuits for the tag.

8. The data processing apparatus according to claim 1, comprising:
level two indication circuitry having a higher capacity than the indication circuitry; and
in response to a miss occurring in the indication circuitry, the level two indication circuitry is searched and when there is a hit on a hitting entry, the hitting entry is transferred to the indication circuitry.

9. The data processing apparatus according to claim 1, wherein
the level two indication circuitry is a base table in which the tags are matched against the partial tag in isolation.

10. The data processing apparatus according to claim 1, wherein
the level two indication circuitry is a base table of a history-based predictor.

11. The data processing apparatus according to claim 8, wherein
in response to the level two indication circuitry being updated with an identity of the one of the storage circuits, the indication circuitry is updated to remove each entry whose partial tag in the indication circuitry is a partial tag of the new tag.

12. The data processing apparatus according to claim 1, wherein
a behaviour of the indication circuitry is divided into a training period followed by a non-training period; and
in response to an end of the non-training period, the indication circuitry is reset.

13. The data processing apparatus according to claim 11, wherein
the training period and the non-training period are defined for each entry of the indication circuitry.

14. The data processing apparatus according to claim 12, wherein
the data items comprise predictions of instruction behaviour; and
the data processing apparatus comprises update circuitry configured to update the subset of the storage circuits stored for the partial tag in response to those of the predictions returned by the access circuitry during the non-training period causing a misprediction.

15. The data processing apparatus according to claim 12, wherein
during the training period, the indication circuitry is configured to indicate the plurality of storage circuits as the subset of the storage circuits, regardless of the input.

16. The data processing apparatus according to claim 1, wherein
in response to particular one of the storage circuits having data in association with a particular tag, the indication circuitry is updated to reference the particular one of the storage circuits for each partial tag in the indication circuitry that is a partial tag of the particular tag.

17. A system comprising:
the data processing apparatus of claim 1, implemented in at least one packaged chip;
at least one system component; and
a board, wherein
the at least one packaged chip and the at least one system component are assembled on the board.

18. A chip-containing product comprising the system of claim 17, wherein the system is assembled on a further board with at least one other product component.

19. A data processing method comprising:
storing data items in association with tags in a plurality of storage circuits;
indicating, for a partial tag that is provided as an input, a subset of the storage circuits where the partial tag is part of the tags stored in that storage circuit;
causing the subset of the storage circuits to be powered to a power level at which the subset of the storage circuits can be accessed; and
searching the subset of the storage circuits for a tag comprising the partial tag once the subset of storage circuits have been powered.

20. A non-transitory computer-readable medium storing computer-readable code for fabrication of the data processing apparatus of claim 1.
